(19) United States
(12) Patent Application Publication
(10) Pub. No.: US 2018/0287158 A1
(43) Pub. Date: Oct. 4, 2018

(54) NEGATIVE ELECTRODE PLATE, METHOD FOR PRODUCING THE SAME, AND SECONDARY BATTERY USING THE SAME

(71) Applicant: CONTEMPORARY AMPEREX TECHNOLOGY CO., LIMITED, Ningde City (CN)

(72) Inventors: Yunjian MA, Ningde City (CN); Wei LI, Ningde City (CN); Haizu JIN, Ningde City (CN); Yikuang JIN, Ningde City (CN)

(21) Appl. No.: 15/917,612

(22) Filed: Mar. 10, 2018

(30) Foreign Application Priority Data
Apr. 1, 2017 (CN) 201710212614.X

(51) Int. Cl. H01M 4/62

(52) U.S. Cl. CPC H01M 4/62; H01M 2004/027

(57) ABSTRACT

Provided is a negative electrode plate. A negative electrode plate includes a negative current collector and a first coating layer arranged on a surface of the negative current collector. The negative electrode plate further includes a second coating layer arranged on a surface of the first coating layer. The first coating layer contains a negative electrode active material. The second coating layer contains a heat-resistant insulating material. The heat-resistant insulating material is selected from an oxide or a hydroxide containing at least one of elements selected from a group consisting of Mg, Si, Zr and Y. In the present application, the second coating layer containing the heat-resistant insulating material is coated on a surface of the conventional negative electrode active material layer, so an instantaneous high power discharge in a short circuit of the secondary battery can be avoided, and a safety performance of the battery can be improved.

### CROSS-REFERENCE TO RELATED APPLICATIONS

The present application claims priority to Chinese Patent Application No. 201710212614.X, filed on Apr. 1, 2017, the content of which is incorporated herein by reference in its entirety.

### TECHNICAL FIELD

The present application relates to the field of secondary batteries and, in particular, relates to a negative electrode plate, a method for producing the negative electrode plate, and a secondary battery using the negative electrode plate.

### BACKGROUND

Secondary battery, also known as rechargeable battery or storage battery, is a battery capable of being reused after discharging. Specifically, after discharging, the secondary battery can be charged to activate an active substance, so as to be reused. At present, the most widely used lithium ion battery is a secondary battery with its positive electrode and negative electrode respectively being formed by two compounds capable of achieving reversible lithium-ion intercalation and de-intercalation. In order to improve a safety performance of the lithium ion battery, the prior art mainly uses the following means, such as depositing or coating the negative electrode, using a passivator within the electrolyte, adopting a high-strength diaphragm, doping and coating a diaphragm, doping and coating a positive electrode, and coating a surface of the positive electrode. Normally, a large number of additives or complex processes are applied to achieve the purpose of improving safety performance.

However, these means tend to significantly deteriorate electrical properties of the battery, for example, increasing an internal impedance of the battery, reducing an energy density and power performance, which leads to an unsatisfied effect. In order to meet a large-scale application of the lithium ion battery and achieve green sustainable development, it is necessary to develop a new negative material.

Aiming at the defects of the prior art, the present application is proposed.

### SUMMARY

A first object of the present application is to provide a negative electrode plate.

A second object of the present application is to provide a method for preparing the negative electrode plate.

A third object of the present application is to provide a secondary battery using the negative electrode plate.

In order to achieve the inventive object of the present application, the technical solution adopted includes:

The present application relates to a negative electrode plate, which includes a negative current collector; a first coating layer arranged on a surface of the negative current collector; and a second coating layer arranged on a surface of the first coating layer; wherein the first coating layer contains a negative electrode active material, the second coating layer contains a heat-resistant insulating material, and the heat-resistant insulating material is selected from an oxide or a hydroxide containing at least one of elements selected from a group consisting of Mg, Si, Zr and Y.

Preferably, the heat-resistant insulating material is at least one selected from a group consisting of Mg(OH)₂, SiO₂, ZrO₂, Y₂O₃ and ZrₓY_{y}O₂, wherein x>0, y>0, x+¾y=1.

Preferably, the heat-resistant insulating material is ZrₓY_{y}O₂, wherein a mass ratio of Zr to Y is in a range from (95:5) to (85:15), preferably 91:9.

Preferably, a particle size of the heat-resistant insulating material is in a range from 1 nm to 50 nm, preferably 20 nm to 50 nm.

Preferably, a thickness of the second coating layer is in a range from 1 μm to 5 μm.

Preferably, an amount of the heat-resistant insulating material is in a range of 1%-10% by mass of the negative electrode active material.

Preferably, the second coating layer further includes a binder and a thickener, wherein a mass ratio of the heat-resistant insulating material, the binder and the thickener is (95-97): (2-3): (1-2).

Preferably, the binder is a water-based binder or an oil-based binder, wherein the water-based binder is at least one selected from a group consisting of styrene-butadiene rubber, aqueous acrylic resin, and carboxymethyl cellulose, and wherein the oil-based binder is at least one selected from a group consisting of polyvinylidene fluoride, ethylenevinyl acetate copolymer and polyvinyl alcohol.

The present application relates to a method for preparing the negative electrode plate, including at least following steps:

a first step, coating a first slurry including the negative electrode active material, a conductive agent and a binder on a surface of the negative current collector to form the first coating layer; and

a second step, coating a second slurry layer including the heat-resistant insulating material, a binder and a thickener on a surface of the first coating layer to form the second coating layer, and to obtain the negative electrode plate.

The present application relates to a secondary battery by adopting the negative electrode plate.

The technical solutions of the present application have at least the following beneficial effects:

In the present application, the second coating layer containing the heat-resistant insulating material is coated on a surface of the conventional negative electrode active material layer, so an instantaneous high power discharge in a short circuit of the secondary battery can be avoided, and a safety performance of the battery can be improved.

### BRIEF DESCRIPTION OF DRAWINGS

FIG. 1 is a structural schematic diagram of a negative electrode plate according to an embodiment of the present application;

FIG. 2 is a scanning electron micrograph of a surface of a negative electrode plate in a comparative example of the present application;

FIG. 3 is a scanning electron micrograph of a cross section of a negative electrode plate in a comparative example of the present application;

FIG. 4 is a scanning electron micrograph of a surface of a negative electrode plate in an embodiment of the present application; and

FIG. 5 is a scanning electron micrograph of a cross section of a negative electrode plate in an embodiment of the present application.

### REFERENCE SIGNS

1-negative current collector;

2-first coating layer;

3-second coating layer.

### DESCRIPTION OF EMBODIMENTS

The present application will be further illustrated as follows with reference to specific embodiments. It should be understood that, these embodiments are only used to explain the present application but not used to limit the scope of the present application.

The present application relates to a negative electrode plate, which includes a negative current collector and a first coating layer arranged on a surface of the negative current collector. The negative electrode plate further includes a second coating layer arranged on a surface of the first coating layer. The first coating layer contains a negative electrode active material. The second coating layer contains a heat-resistant insulating material. The heat-resistant insulating material may be selected from an oxide or a hydroxide of at least one of elements selected from a group consisting of Mg, Si, Zr and Y. In the present application, the second coating layer containing the heat-resistant insulating material is coated on a surface of the conventional negative electrode active material layer, so as to improve the safety performance of the secondary battery.

As an improvement of the negative electrode plate of the present application, the heat-resistant insulating material may be selected from at least one of Mg(OH)₂, SiO₂, ZrO₂, Y₂O₃ and ZrₓY_{y}O₂, where the coefficients meet the relations of x>0, y>0, x+¾y=1. Compared with the heat-resistant insulating material containing aluminum, such as Al₂O₃, AlOOH, Al(OH)₃ and the like, the heat-resistant insulating material provided by the present application has a higher diaphragm resistance, which facilitates a significant improvement of the safety performance of the battery.

Among the above-mentioned heat-resistant insulating materials, ZrₓY_{y}O₂ is further preferred. A mass ratio of Zr to Y is substantially in a range from (95:5) to (85:15), preferably 91:9. Specifically, the ZrₓY_{y}O₂ containing 9% by mass of Y is a cubic phase with a lattice constant a=5.125, a melting point of 2800° C., a thermal expansion coefficient of 10.3×10⁻⁶/° C., and with properties of electric insulation and good ion-conduction. It can be understood that, when Y₂O₃ is doped in the ZrO₂ crystal, the Zr ion is substituted by the Y ion in the lattice, which reduces an O²⁻ ratio to form an oxygen vacancy and thus achieves a better ion-conduction performance. The ZrₓY_{y}O₂ crystal can also be represented as (Zr,Y)O₂, which has a similar composition of crystalline grain Pu_{0.090}Y_{0.153}Zr_{0.757}O₂ described in Synthesis of “(Zr,Y,Aₘ)O₂₋ₓtransmutation targets, Journal of Nuclear Materials 433 (2013) 314-318”.

The heat-resistant insulating material of the present application is coated on a surface of the first coating layer containing the negative electrode active material, which has a remarkable effect for improving the safety performance of the battery. In case of nailing test, there are four short-circuit modes when the battery is nailed. The four short-circuit modes include a short circuit caused by a contact between a positive current collector and a negative electrode active material, a short circuit caused by a contact between a positive current collector and a negative current collector, a short circuit caused by a contact between a positive electrode active material and a negative electrode active material, and a short circuit caused by a contact between a positive electrode active material and a negative current collector. In the above four short-circuit modes, the most dangerous mode is the short circuit caused by the contact between an aluminum foil of the positive current collector and the active material on the surface of the negative electrode, since a short circuit resistance of this short circuit mode is the smallest and a short circuit power is the largest. If the surface of the first coating layer of the negative electrode is provided with a second coating layer with electric insulation effect, the phenomenon of burning and explosion caused by a high-power discharge of the battery at the moment of short circuit would be maximally avoided. In addition to the electric insulation effect, the second coating layer shall, at the same time, have a good ion transportation capacity, otherwise, overall performance of a cell may be deteriorated. Applicant's studies have found that the oxide or hydroxide of elements such as Mg, Si, Zr, Y and the like have these properties. Except for the use of these heat-resistant insulating materials on the negative electrode by arranging the second coating layer on the surface of the first coating layer, it is also possible to coat a slurry prepared by mixing the heat-resistant insulating material with the negative electrode active material on the surface of the negative current collector, or to form a coating layer by the heat-resistant insulating material on the surface of the negative electrode active material, and then to mix with a solvent to prepare a slurry and coat the slurry on the surface of the negative current collector. The latter two manners can avoid the negative material from directly contacting with an electrolyte so as to improve the cycle performance. However, in the nailing test and other abuse experiments, the safety performance of the battery does not significantly improve. Moreover, these heat-resistant insulating material may also be coated on a surface of a separator, and the effect is similar to coating an AlOOH layer on the surface of the first coating layer of the negative electrode plate, both of them do not show a significant effect on improving the safety performance, and which, on the country, may increase an internal polarization of the cell.

As an improvement of the negative electrode plate of the present application, a particle size of the heat-resistant insulating material may be substantially in a range from 1 nm to 50 nm, preferably 20 nm to 50 nm. Within such a range of the particle size, it is possible to realize a good dispersion of the heat-resistant insulating material on the surface of the first coating layer containing the negative electrode active material, while an adverse effect on the internal structure of the cell can be avoided due to an excessive thickness of the second coating layer. More preferably, a lower limit of the particle size of the heat-resistant insulating material may be selected from the group consisting of 1 nm, 5 nm, 10 nm, 15 nm, and 20 nm; and an upper limit thereof may be selected from 25 nm, 30 nm, 35 nm, 40 nm and 50 nm.

As an improvement of the negative electrode sheet of the present application, an amount of the heat-resistant insulating material may be substantially 1-10% by mass of the negative electrode active material. When the amount of the heat-resistant insulating material is too small, an improvement of heat-resistant insulating performance may not be significant. When the amount of the heat-resistant insulating materials is too much, a heat-resistant performance of the negative electrode plate may be enhanced, but an energy density of the negative electrode plate may be decreased. More preferably, a lower limit of the amount of the heat-resistant insulating material may be selected from 1%, 2%, 3%, 5% by mass of the negative electrode active material, and an upper limit may be selected from 6%, 8%, 9%, 10% by mass of the negative electrode active material.

As an improvement of the negative electrode sheet of the present application, a thickness of the second coating layer may be substantially in a range from 1 μm to 5 μm. When the thickness of the second coating layer is too thin, an improvement of the safety performance of the battery may not be significant, and a too thin coating layer may also bring difficulties to a preparation process. When the thickness of the second coating layer is too thick, the internal structure of the cell may be affected, which may result in winding difficulties and other adverse effects.

Furthermore, the second coating layer contains a binder and a thickener.

The present application further relates to a method for preparing a negative electrode plate, including at least following steps:

a first step, coating a first slurry including a negative electrode active material, a conductive agent and a binder on a surface of a negative current collector to form a first coating layer; and

a second step, coating a second slurry layer including a heat-resistant insulating material, a binder and a thickener on a surface of the first coating layer to form a second coating layer, and to obtain the negative electrode plate.

In the first step, the negative electrode active material may be at least one selected from the group consisting of graphite, soft carbon, hard carbon, silicon materials and lithium titanate. The negative electrode active material may also be at least one selected from the group consisting of graphite-hard carbon mixed material, graphite-silicon composite material, graphite-hard carbon-silicon material and other composite materials. The silicon material may be at least one selected from the group consisting of Si alloy, SiOₓ, silicon/carbon composite materials, where the coefficient meets the relation of 0.5<×<2.The Hard carbon is carbon black or a carbon material prepared by thermal decomposition of a carbonaceous precursor. A temperature of the thermal decomposition is usually about 1000° C. The carbonaceous precursor may be selected from a group consisting of phenolic resin, epoxy resin, melamine resin, polyfurfuryl alcohol, polyphenylene, polyacrylonitrile, polyvinyl chloride, polyvinylidene fluoride, polyphenylene sulfide, polynaphthalene, cellulose and the like.

In the first step, the conductive agent may be selected from at least one of a zero-dimensional carbon material, a one-dimensional carbon material and a two-dimensional carbon material. Preferably, the zero-dimensional carbon material may be at least one of conductive carbon black and acetylene black, the one-dimensional carbon material may be at least one selected from the group consisting of carbon fiber and carbon nanotube, and the two-dimensional carbon material may be at least one selected from the group consisting of graphite, graphene and carbon nanotube. Commonly used conductive agents include Keqin black (ultra-fine conductive carbon black, with a particle size of 30 nm-40 nm), SP (Super P, small particle conductive carbon black, with a particle size of 30 μm-40 μm), SO (ultra-fine graphite powder, with a particle size of 3 μm-4 μm), KS-6 (large particle graphite powder, with a particle size of 6.5 μm), acetylene black, VGCF (vapor-growth carbon fiber, with a particle size of 3 μm-20 μm).

In the first and second steps, the binder is a water-based binder or an oil-based binder. The water-based binder may be at least one selected from the group consisting of styrene-butadiene rubber, aqueous acrylic resin, and carboxymethyl cellulose. The oil-based binder may be at least one selected from the group consisting of polyvinylidene fluoride, ethylenevinyl acetate copolymer and polyvinyl alcohol (PVA).

In the second step, the thickener may be selected from the carboxymethyl cellulose (CMC).

In the second step, a mass ratio of the heat-resistant insulating materials, the binder and the thickener being within a reasonable range can facilitate a good density and a fine granularity of the second coating layer can be formed. The mass ratio may be substantially (95-97):(2-3):(1-2), preferably 95:3:2.

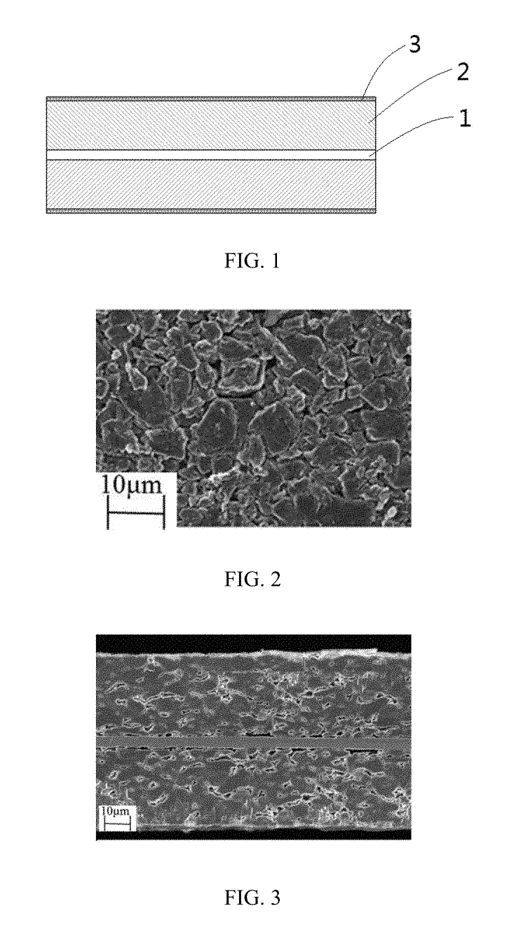

The present application further relates to a secondary battery using the above-mentioned negative electrode plate. Specifically, the secondary battery includes a positive electrode plate, a negative electrode plate, a separator, and an electrolyte. The secondary battery of the present application may preferably be a lithium ion battery. The positive electrode plate includes a positive current collector and a positive electrode diaphragm coated on the positive current collector; the negative electrode plate includes a negative current collector 1, a first coating layer 2 and a second coating layer 3 which are coated on the negative current collector 1; the electrolyte includes a lithium salt and an organic solvent; and the separator is located between the adjacent positive and negative electrode plates. In the present application, it is preferred that the first coating layer 2 and the second coating layer 3 are respectively coated on two surfaces of the negative current collector 1, and the schematic view thereof is shown in FIG. 1.

As an improvement of the secondary battery of the present application, the positive electrode active materials may be one or more selected from the group consisting of lithium cobaltate, lithium manganate, and lithium nickel cobalt manganate Li (NiₓMn_{y}Co_{z})O₂ (0<x, y, z<1, x+y+z=1).

As an improvement of the secondary battery of the present application, the lithium salt may be at least one selected from the group consisting of lithium hexafluorophosphate (LiPF₆), lithium tetrafluoroborate (LiBF₄), lithium bis(oxalate) borate (LiB(C₂O₄)₂, abbreviated as LiBOB), lithium difluoro(oxalato)borate (LiBF₂(C2O₄), abbreviated as LiDFOB), lithium hexafluoroarsenate (LiAsF₆), lithium perchlorate (LiClO₄), lithium tris (perfluoroethyl) trifluorophosphate (LiFAP), lithium trifluoromethanesulfonate (LiCF₃SO₃), bis(trifluoromethanesulfonyl) methyllithium (Li(FSO₂)₂N), lithium bis(trifluoromethanesulfonyl) imine (LiN(CF₃SO₂)₂), lithium bis(perfluoroethanesulfonyl) imine (Li(C₂F₅SO₂)₂N), lithium bis(perfluorobutanesulfonyl) imine (Li(C₄F₉SO₂)₂N), and Li(SO₂(CF₂)₃SO₂)₂N. The lithium salt may preferably beat least one selected from the group consisting of LiPF₆, LiBF₄, and Li(FSO₂)₂N.

As an improvement of the secondary battery of the present application, the organic solvent may be at least one selected from the group consisting of carbonates, sulfates, sulfones, nitrile compounds and the like. The carbonates may be selected from the group consisting of cyclic carbonates, chain carbonates and the like. The sulfates may be selected from cyclic sulfate, chain sulfate, and the like. The following organic solvent may be selected from, but is not limited to, the group consisting of ethylene carbonate, propylene carbonate, dimethylcarbonate, diethylcarbonate, dipropyl carbonate, methyl ethyl carbonate, methyl formate, ethyl formate, Ethyl propionate, propyl propionate, methyl butyrate, ethyl acetate, ethylene sulfite, fluoroethylene carbonate, propanesultone, N-Methyl pyrrolidone, N-Methylformamide, N-Methylacetamide, Acetonitrile, Acrylonitrile, γ-butyrolactone, methyl sulfide, cyclohexylbenzene, and biphenyl.

Furthermore, the lithium ion battery is a wound lithium ion battery or a stacked lithium ion battery.

The present application is described in detail below with reference to the embodiments, but the present application is not limited to these embodiments.

In the embodiments, the heat-resistant insulating material, such as Mg(OH)₂, SiO₂, ZrO₂, Y₂O₃ and ZrₓY_{y}O₂, is purchased from Changsha Zhong long Chemical, the particle size was 20 nm-50 nm, the mass ratio of Zr to Y in ZrₓY_{y}O₂ was 91:9, and the conductive carbon black was purchased from Shanghai Kajit Chemical Technology Co., Ltd.

### Embodiment 1

Preparation of the Negative Electrode Plate

Mix the artificial graphite as the negative electrode active material with the SP as the conductive agent, the styrene-butadiene rubber as the binder, and the CMC (carboxymethyl cellulose) as the thickener at a weight ratio of 96.2:1.5:1.5:0.8, add deionized water as a solvent, and then mix and stir uniformly at a vacuum condition, to prepare a first slurry. The first slurry is uniformly coated on a copper foil as the negative current collector, then dried at 80-90° C. after coating, and then subjected to cold pressing, trimming, cutting, slitting, and then dried at 110° C. under vacuum for 4 h to obtain a first coating layer.

Mix the heat-resistant insulating material with the styrene-butadiene rubber as the binder, and the CMC as the thickener at a weight ratio of (95-97):(2-3):(1-2), add the deionized water as a solvent, and then mix and stir uniformly at a vacuum condition, to prepare a second slurry. An amount of the heat-resistant insulation material is substantially in a range from 1% to 10% by mass of the negative electrode active material. The second slurry is uniformly coated on the first coating layer, then dried at 80-90° C. after coating, and then subjected to cold pressing, trimming, cutting and slitting to obtain a second coating layer. The negative electrode plates 1 to 10 are obtained in the above manner, where specific types, particle sizes and amounts of the heat-resistant insulating material and a thickness of the second coating layer were shown in Table 1.

Preparation of the Positive Electrode Plate

The LiNi_{1/3}Mn_{1/3}CO_{1/3}O₂ (NCM333) as the positive electrode active material, the carbon black SP as the conductive agent, and the polyvinylidene fluoride as the binder are mixed, and a weight ratio of the three is 97:2:1. The N-methyl-pyrrolidone as the solvent is added, and then mixed and stirred uniformly at a vacuum condition, to obtain a positive electrode slurry. Then, the positive electrode slurry is uniformly coated on an aluminum foil as the positive current collector, then dried at 85° C., and then subjected to cold pressing, trimming, cutting and slitting, followed by drying at 85° C. for 4 hours to obtain a positive electrode plate.

Preparation of the Lithium Ion Battery

A polyethylene film with a thickness of 12 μm is used as the separator, and a concentration of lithium hexafluorophosphate in the electrolyte was 1 mol/L. An organic solvent in the electrolyte is composed of ethylene carbonate, dimethyl carbonate and 1,2-propylenecarbonate (volume ratio 1:1:1).

The negative electrode plate, the separator and the positive electrode plate are sequentially stacked, and the separator is between the positive electrode plate and the negative electrode plate, and then wound into a square bare cell having a thickness of 8 mm, a width of 60 mm and a length of 130 mm. The bare cell is packaged in an aluminum foil bag, vacuum baked at 75° C. for 10 h, injected with a non-aqueous electrolyte, vacuum packaged and stands for 24 hours, then charged at a constant current of 0.1 C(160 mA) to 4.2V, and then charged at the 4.2V constant voltage to a current down to 0.05 C(80 mA), and then discharged at 0.1 C(160 mA) constant current to 3.0V, repeat the charge and discharge twice, and finally charged at 0.1 C(160 mA) constant current to 3.8V, then the preparation of the lithium-ion secondary battery is completed. The batteries 1 to 10 were obtained in the above-described manner.

TABLE 1

| | | Types and amount of | Mass ratio of the | |
|---|---|---|---|---|
| | | the heat-resistant | heat-resistant | |
| | | insulating material | insulating | |
| | Negative | (compared with the | material, the | Thickness of the |
| Battery | electrode plate | negative electrode | binder and the | second coating |
| No. | No. | active material) | thickener | layer (μm) |
| Battery 1 | Electrode plate 1 | 5% ZrₓY_{y}O₂ | 95:3:2 | 5 |
| Battery 2 | Electrode plate 2 | 3% ZrₓY_{y}O₂ | 97:2:1 | 5 |
| Battery 3 | Electrode plate 3 | 1% ZrₓY_{y}O₂ | 95:3:2 | 5 |
| Battery 4 | Electrode plate 4 | 10% ZrₓY_{y}O₂ | 95:3:2 | 5 |
| Battery 5 | Electrode plate 5 | 5% ZrₓY_{y}O₂ | 95:3:2 | 3 |
| Battery 6 | Electrode plate 6 | 5% ZrₓY_{y}O₂ | 95:3:2 | 7 |
| Battery 7 | Electrode plate 7 | 5% ZrO₂ | 95:3:2 | 5 |
| Battery 8 | Electrode plate 8 | 5% Y₂O₃ | 95:3:2 | 5 |
| Battery 9 | Electrode plate 9 | 5% Mg(OH)₂ | 95:3:2 | 5 |
| Battery 10 | Electrode plate 10 | 5% SiO₂ | 95:3:2 | 5 |

Compared with a preparing process of the battery 1, differences of a preparing process of the positive electrode plate, the negative electrode plate and the battery of the batteries 1# to 9# are:

A negative current collector of the battery 1# only contains a first coating layer, without using the heat-resistant insulating material, and the corresponding negative electrode plate is the electrode plate 1#.

For batteries 2# and 3#, prepare a first coating layer on the negative current collector firstly, and then prepare a second coating layer with an aluminum-based heat-resistant insulating material, a thickness of the second coating layer is 5 μm, the corresponding negative electrode plates are the electrode plates 2# and 3#.

The batteries 4# to 6# are prepared by mixing the heat-resistant insulating material with the negative electrode active material directly, adding the conductive agent, the binder, the thickener and the solvent to form a slurry, and preparing a coating layer on the negative current collector. The corresponding negative electrode plates are the electrode plates 4# to 6#. An amount of the heat-resistant insulating material is 5% by mass of the negative electrode active material

The batteries 7# and 8# are prepared by preparing a first coating layer on the negative current collector, and then applying a second slurry containing an heat-resistant insulating material and a binder to a surface of the separator, to prepare a coating layer on the separator. The thickness of the coating layer is about 5 μm, and the corresponding negative electrode plates are the electrode plates7# and 8#.

The battery 9 # is prepared by preparing a first coating on the negative current collector, and then applying a second slurry containing the heat-resistant insulating material and the binder to a surface of the positive electrode plate containing the positive electrode diaphragm. The coating layer has a thickness of 5 μm and the corresponding negative electrode plate is the electrode plate 9 #.

The specific types, amount and location of the heat-resistant insulating material are shown in Table 2.

TABLE 2

| | | Types and amount of | |
|---|---|---|---|
| | | the heat-resistant | |
| | | insulating material | |
| | | (compared with the | Position of the |
| | Negative electrode | negative electrode | heat-resistant insulating |
| Battery No. | plate No. | active material) | material |
| Battery 1# | Electrode plate 1# | — | — |
| Battery 2# | Electrode plate 2# | 5% Al₂O₃ | Second coating layer |
| Battery 3# | Electrode plate 3# | 5% Al(OH)₃ | Second coating layer |
| Battery 4# | Electrode plate 4# | 5% Al(OH)₃ | Negative current collector |
| Battery 5# | Electrode plate 5# | 5% ZrₓY_{y}O₂ | Negative current collector |
| Battery 6# | Electrode plate 6# | 5% Al₂O₃ | Negative current collector |
| Battery 7# | Electrode plate 7# | 5% Al₂O₃ | Separator |
| Battery 8# | Electrode plate 8# | 5% ZrₓY_{y}O₂ | Separator |
| Battery 9# | Electrode plate 9# | 5% ZrₓY_{y}O₂ | Positive electrode plate |

Where “—” indicates that a substance is not used.

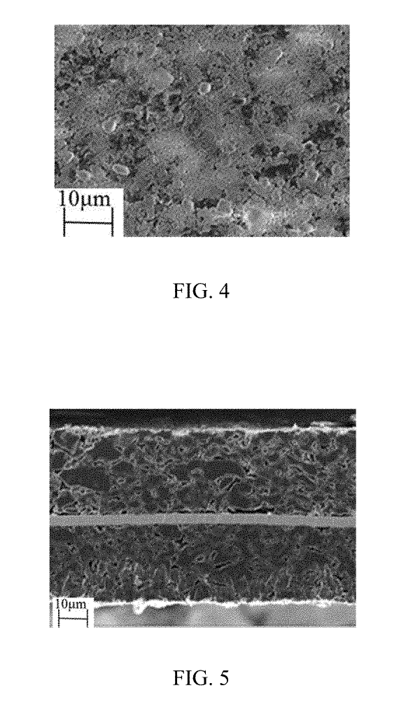

Scanning electron micrographs of the electrode platel and the electrode plate 1190 are shown in FIGS. 2-5. It can be seen that, a surface of the electrode plate 1# is distributed with larger particles of the negative electrode active material. FIG. 3 is a cross-sectional view of the electrode plate 1#, and a first coating layer containing the negative electrode active material is arranged on both sides of the negative current collector. FIG. 4 shows a surface topography of the electrode plate 1, and it can be seen that, the particles of the heat-resistant insulating material on the surface of the second coating layer are smaller than the particles of the negative electrode active material. FIG. 5 is a cross-sectional view of the electrode plate 1, and it can be seen that, the second coating layer with a thickness of 1-5 μm is arranged on the surface of the first coating layer.

### Test Examples

Electrode Plate Test:

A thickness of the electrode plate of the negative electrode plate is measured by a millet.

A diaphragm resistance of the negative electrode plate is measured by a combination of an alternating current internal resistance detector and an electrode tablet press.

A battery internal resistance is measured by the alternating current internal resistance detector.

Magnification Performance and Safety Performance Test:

After a battery is fully charged to 1 C at 25±2° C., discharged at 1C, fully charged to 1 C, and then discharged at 3 C. Test an energy percentage of the battery discharged at 3 C with respect to discharged at 1 C, recorded as 3 C discharge capacity. A voltage range is in a range from 3.0V to 4.2V.

The safety performance is tested by a nailing test, and the method is that using ϕ5 mm stainless steel needle (spindle angle 30-60°) at 25° C.±2° C., passing through a center of the battery at a speed of 25 mm/s, and monitoring a change in cell surface temperature. The results of the tests are shown in Table 3.

TABLE 3

| | Thickness | | | | |
|---|---|---|---|---|---|
| | of the | | | | |
| | negative | | | | |
| | electrode | Diaphragm | Internal | Safety | 3 C discharge |
| No. | plate/μm | resistance/mΩ | resistance/mΩ | performance | capacity |
| Battery 1 | 130 | 3.7 | 1.72 | No spark, No | 82% |
| | | | | burning | |
| Battery 2 | 130 | 3.6 | 1.70 | Spark, smoke | 83% |
| Battery 3 | 130 | 3.4 | 1.68 | Burning | 85% |
| Battery 4 | 130 | 3.9 | 1.74 | No spark, No | 78% |
| | | | | burning | |
| Battery 5 | 128 | 3.7 | 1.72 | No spark, No | 82% |
| | | | | burning | |
| Battery 6 | 132 | 3.7 | 1.71 | No spark, No | 82% |
| | | | | burning | |
| Battery 7 | 130 | 4.1 | 1.78 | Spark, smoke | 78% |
| Battery 8 | 130 | 3.9 | 1.73 | Spark, smoke | 81% |
| Battery 9 | 130 | 3.8 | 1.72 | Spark, smoke | 82% |
| Battery 10 | 130 | 5.1 | 1.90 | Spark, smoke | 58% |
| Battery 1# | 125 | 2.9 | 1.48 | Burning | 87% |
| Battery 2# | 130 | 3.9 | 1.65 | Burning | 84% |
| Battery 3# | 130 | 3.5 | 1.67 | Burning | 83% |
| Battery 4# | 125 | 3.3 | 1.58 | Burning | 85% |
| Battery 5# | 125 | 3.4 | 1.55 | Burning | 86% |
| Battery 6# | 125 | 3.2 | 1.59 | Burning | 85% |
| Battery 7# | 125 | 2.9 | 1.52 | Burning | 86% |
| Battery 8# | 125 | 2.9 | 1.51 | Burning | 86% |
| Battery 9# | 125 | 2.9 | 1.54 | Burning | 86% |

It can be seen from Table 1 to Table 3, since the second coating layer is prepared on the surface of the first coating layer to reduce an energy density of the negative electrode plate. Therefore, the thickness of the negative electrode diaphragm in the embodiment is increased as compared with the battery 1#.

Compared the test results of the batteries 1, 2, 5, 6 with the batteries 3 and 4, if the second coating layer contains an appropriate amount of the heat-resistant insulating material (the amount is 3-5% by mass of the negative electrode active material), the electrode plate resistance and the battery internal resistance would be increased, which do not burn after the nailing test, and has a good safety performance. On the contrary, in the use of the same type of heat-resistant insulating material, if the amount of heat-resistant insulating material is too low (1%), a rise value of the battery internal resistance is not large, and cannot pass the nailing test. If the amount of heat-resistant insulating material is too high (10%), although it can be pass the nailing test, but an addition amount of the heat-resistant insulating material means decreasing the amount of the negative electrode active material, resulted in a decrease in the energy density and a significant reduction in the rate performance.

In the battery 1#, a second coating layer does not use the heat-resistant insulating material, and the diaphragm resistance and internal resistance are low, and burned directly after the nailing test.

Batteries 2# and 3 use the aluminum-based insulating heat-resistant material to prepare a second coating layer. The diaphragm resistance and the internal resistance are improved as compared with the battery 1#, but still lower than the embodiments. Burned after the nailing test.

The batteries 4# to 6# use an aluminum base and the heat-resistant insulating material of the present application, which are directly mixed with the negative electrode active material, to prepare a coating layer on the negative current collector, and there is no significant improvement in the safety performance shown in the nailing test of the battery.

The batteries 7# to 9# coat the aluminum base and the heat-resistant insulating materials of the present application on the separator and the positive electrode plate separately, and there is no significant improvement in the safety performance of the battery.

Cycle Performance Test

The battery 1 and battery 1# at 25° C. under a 1 C/1 C cycle test, the specific test method is as follows:

1) Adjust the battery temperature to 25° C., and stand for 5min;

2) Charge at 1 C constant current to 4.2V, then charge at 4.2V constant voltage to 0.05 C, and stand for 5 min;

3) Discharge at 1C constant current to 3.0V, and stand for 5 min;

4) Repeat steps 2) to 5) until a capacity degradation is less than 80%. The number of cycles when the capacity is less than 80% is recorded as a total number of cycles, the results are shown in Table 4.

TABLE 4

| No. | Cycle performance test |
|---|---|
| Battery 1 | 3600 cycles |
| Battery 1# | 3400 cycles |

As shown in Table 4, a second coating layer can effectively protect the negative electrode plate, reduce an occurrence of side effects on the surface of the negative electrode plate, and improve the battery cycle performance in a certain degree.

Although the present application is disclosed by the preferred embodiments as above, but they will not limit the claims. Those skilled in the art can make any possible variations and modifications according to the concept of the present application, therefore, the protection scope of the present application should be defined by the claims of the present application.

What is claimed is:

1. A negative electrode plate, comprising:
a negative current collector;
a first coating layer arranged on a surface of the negative current collector; and
a second coating layer arranged on a surface of the first coating layer;
wherein the first coating layer contains a negative electrode active material, the second coating layer contains a heat-resistant insulating material, and the heat-resistant insulating material is selected from an oxide or a hydroxide containing at least one of elements selected from a group consisting of Mg, Si, Zr and Y.

2. The negative electrode plate according to claim 1, wherein the heat-resistant insulating material is at least one selected from a group consisting of Mg(OH)₂, SiO₂, ZrO₂, Y₂O₃ and ZrₓY_{y}O₂, wherein x>0, y>0, x+¾y =1.

3. The negative electrode plate according to claim 2, wherein the heat-resistant insulating material is ZrₓY_{y}O₂, wherein a mass ratio of Zr to Y is in a range from (95:5) to (85:15), preferably 91:9.

4. The negative electrode plate according to claim 1, wherein a particle size of the heat-resistant insulating material is in a range from 1 nm to 50 nm, preferably 20 nm to 50 nm.

5. The negative electrode plate according to claim 1, wherein a thickness of the second coating layer is in a range from 1 μm to 5 μm.

6. The negative electrode plate according to claim 1, wherein an amount of the heat-resistant insulating material is in a range of 1%-10% by mass of the negative electrode active material.

7. The negative electrode plate according to claim 1, wherein the second coating layer further comprises a binder and a thickener, wherein a mass ratio of the heat-resistant insulating material, the binder and the thickener is (95-97): (2-3): (1-2).

8. The negative electrode plate according to claim 7, wherein the binder is a water-based binder or an oil-based binder, wherein the water-based binder is at least one selected from a group consisting of styrene-butadiene rubber, aqueous acrylic resin, and carboxymethyl cellulose, and wherein the oil-based binder is at least one selected from a group consisting of polyvinylidene fluoride, ethylenevinyl acetate copolymer and polyvinyl alcohol.

9. A method for preparing the negative electrode plate according to claim 1, comprising following steps:
a first step, coating a first slurry comprising the negative electrode active material, a conductive agent and a binder on a surface of the negative current collector to form the first coating layer; and
a second step, coating a second slurry layer comprising the heat-resistant insulating material, a binder and a thickener on a surface of the first coating layer to form the second coating layer, and to obtain the negative electrode plate.

10. A secondary battery, wherein the secondary battery adopts the negative electrode plate according to claim 1.
